(19) United States
(12) Patent Application Publication
(10) Pub. No.: US 2016/0236668 A1
(43) Pub. Date: Aug. 18, 2016

(54) Air Dryer Bypass Device and System

(71) Applicant: Richard Mortvedt, Mountain Home, AR (US)

(72) Inventor: Richard Mortvedt, Mountain Home, AR (US)

(21) Appl. No.: 15/019,208

(22) Filed: Feb. 9, 2016

Related U.S. Application Data
(60) Provisional application No. 62/115,201, filed on Feb. 12, 2015.

(51) Int. Cl. B60T 17/00; B60T 17/04

(52) U.S. Cl. CPC B60T 17/004; B60T 17/04

(57) ABSTRACT

An air dryer bypass device and system for use with a compressed air system. The air dryer bypass device provides a safety bypass that allows a compressed air system to continue to function after an air dryer becomes clogged. The present invention includes a device with an intake port, an output port and a port configured to connect to an air governor. A one-way check valve is positioned near the intake port, and is configured to prevent air from flowing back out toward the intake port. There is an inner passageway that connects all three ports. The ports are configured to connect to a complete compressed air system. The device also provides a mounting plate for installation. The air dryer bypass device is adapted to be a complete replacement of an air dryer system.

### CROSS REFERENCE TO RELATED APPLICATIONS

This application claims the benefit of U.S. Provisional Application No. 62/115,201 filed on Feb. 12, 2015. The above identified patent application is herein incorporated by reference in its entirety to provide continuity of disclosure.

### BACKGROUND OF THE INVENTION

The present invention relates to compressed air systems. More specifically, the present invention relates to an air dryer bypass device on a vehicle-mounted air compressor system that permits the compressed air to bypass an air dryer and flow to an air tank while still being regulated by an air governor device.

Compressed air is often used to power the braking systems of heavy vehicles, including the ubiquitous tractor-trailer transportation truck. Air systems can offer a certain level of safety and reliability that conventional hydraulic braking systems lack. The three main components of a compressed air system are the compressor, the air dryer, and the air storage tank, also known as a wet tank. After the air pressure is increased in the compressor, it passes through the air dryer to remove moisture, water vapor, or impurities from the air, which can cause occasional issues when introduced to the rest of the compressed air system. From the dryer, the air passes to the air storage tank, where it is stored and released when needed by the brakes or other vehicle components that rely on the compressed air system.

Although an air dryer is useful, it can become clogged or blocked due to a buildup of impurities or failing mechanics within the dryer. When this happens, the entire compressed air system is compromised, leading to inadequate air pressure in the system which may cause, among other things, brake failure. In order to address these issues, there exists in the prior art air dryer devices with a temporary bypass valve. The prior art also discloses an air dryer that is easily removable when clogged. These devices fail to provide a permanent bypass device designed for extended use that can be easily installed on a vehicle.

### SUMMARY OF THE INVENTION

In view of the foregoing disadvantages inherent in the known types of air dryer systems now present in the prior art, the present invention provides an air dryer bypass device wherein the same can be utilized for providing convenience for the user when an air dryer incorporated within a compressed air system fails. The present invention comprises a housing that is designed to contain pressurized air. The housing contains an intake port, an output port, and a port connectable to an air pressure regulator. A one-way check valve is positioned near the intake port, and is configured to prevent air from flowing back out toward the intake port. All three ports are in fluid communication through an inner passageway. The present invention is configured to connect to an existing compressed air system by replacing an air dryer completely.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout. As used herein, unless specifically limited to a single unit, “a” or “an” is intended to be equivalent to “one or more” throughout the present disclosure. The singular form is used in the interest of economy.

FIG. 1 shows a cross sectional view of an embodiment of the air dryer bypass device.

FIG. 2 shows a schematic diagram of an embodiment of the air dryer bypass system.

### DETAILED DESCRIPTION OF THE INVENTION

Reference is made herein to the attached drawings. Like reference numerals are used throughout the drawings to depict like or similar elements of the air dryer bypass device. The figures are intended for representative purposes only and should not be considered to be limiting in any respect.

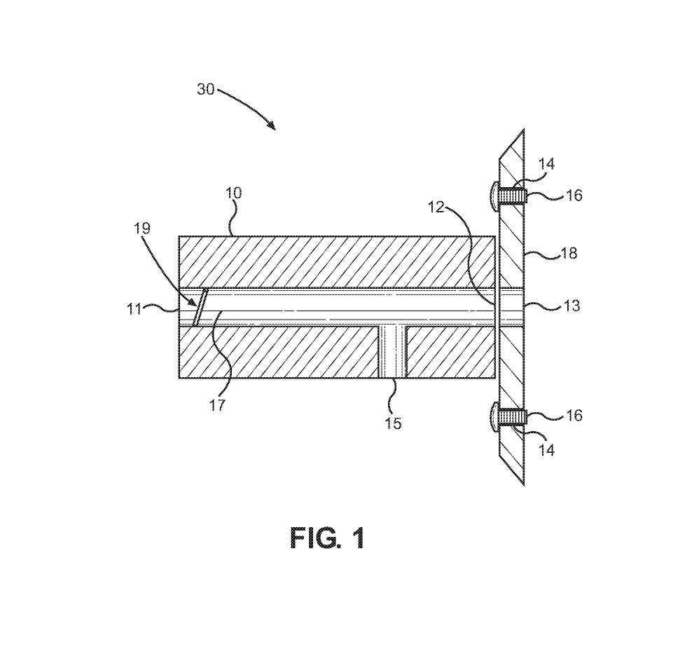

Referring now to FIG. 1, there is shown a cross-sectional view of an embodiment of the air dryer bypass device. The air dryer bypass device 30 comprises a housing 10 having an inner passageway 17 extending therethrough. There is an intake port 11, an output port 12 and a regulator port 15 in fluid communication with the inner passageway 17. All three ports are disposed on the exterior of the housing 10. A one way valve 19 is disposed within the inner passageway 17 and configured to prevent air from exiting the passageway via the intake port. A plate 18 is disposed on the exterior of housing 10 adjacent to the output port 12. The plate 18 comprises and aperture 13 that is aligned with the output port 12, as well as a means for securing the plate to a surface. For example, there can be one or more apertures 14 adapted to admit a fastener therethrough, such as a bolt 16.

The plate 18 is configured to be mounted to a surface to allow the air dryer device to be secured in place. In one embodiment of the invention, the plate 18 can be configured to be mounted directly to the wall of an air storage tank. In another embodiment of the invention, the plate can be configured to be mounted to an alternative surface, such as the underside of a tractor, or a purge tank, wherein a hose runs from the output port 12 and through the aperture 13 to an air storage tank.

The intake port 11 is connectable to an air compressor, the output port 12 is connectable to an air storage tank and the regulator port 15 is connectable to an air pressure regulator device. These ports can be directly or indirectly connected to the rest of the compressed air system. For example, each port can have a threaded adapter attached thereto, configured to connect to a standard air hose. Alternatively, one or more ports can be directly connected to an external unit. For example, the output port 12 can be directly connected to an air storage tank through the aperture 13 without the use of a hose. In one embodiment of the invention, there is a singular output port 12. In another embodiment of the invention, there is a plurality of output ports. These ports can be positioned either on one side of the exterior of the housing, or on multiple sides of the exterior of the housing. For example, there can be one output port on one side of the housing exterior configured to connect to an air storage tank, and four additional ports disposed on each of two additional sides of the exterior housing. These ports can be configured to connect directly with additional features of the compressed air system, such as air brakes, air shocks, a wet tank and a safety pressure release valve.

The one way valve 19 comprises a flap in close proximity to the intake port 11 configured to block air from exiting the inner passageway 17 via the intake port 11. This is accomplished by configuring the flaps to create an air-tight seal when the direction of air flow changes from entering the intake port 11 to exiting the intake port. In one embodiment of the invention, the flap is a disk that is fit in close tolerance to the inner passageway 17. In the normal operation of the air dryer bypass device 30, compressed air flows in from a compressor to the input port 11, through the inner passageway 17, and out through the output port 12 and the regulator port 15. If compressed air starts to flow in the opposite direction, exiting the inner passageway 17 through the input port 11, the compressed air forces the one way valve 19 to close and seal the inner passageway 17, preventing any loss of compressed air.

The regulator port 15 is an output port wherein a portion of the pressurized air entering the passageway 17 is routed through the regulator port 15 to a regulator device known in the prior art, such as an air governor, which is additionally connected to an air compressor. The air governor contains a mechanism such that when the air entering the air governor reaches a predetermined amount of compression, the mechanism will relay a shut off command to the air compressor, thus ensuring that the air does not exceed the predetermined maximal pressure.

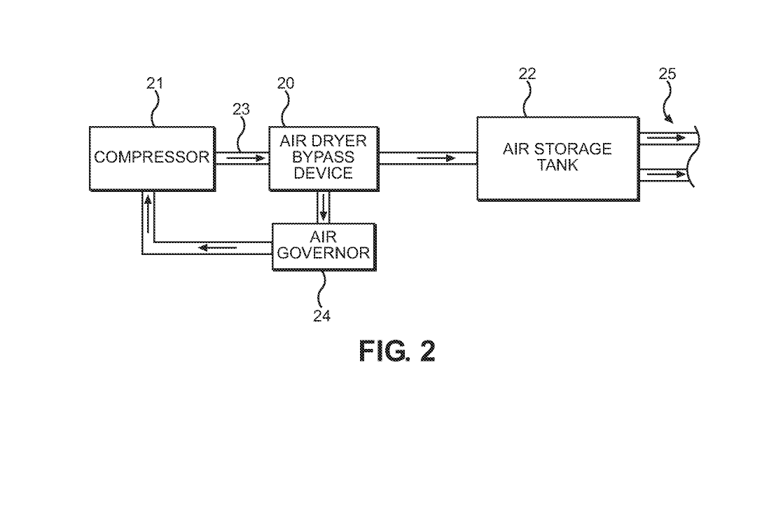

Referring now to FIG. 2, there is shown a schematic diagram of an embodiment of the air dryer bypass system. The system comprises an air compressor 21 that is known in the prior art and that is in fluid communication with the air dryer bypass device 20. For example, the air compressor 21 and the air dryer bypass device 20 can be connected though an airtight hose 23. The device 20 is additionally in fluid communication with an air storage tank 22, which acts as a reservoir to hold a large amount of compressed air until it is ready to be released for use in the system through various output channels 25. The air dryer bypass device 20 is in further fluid communication with an air regulator device such as an air governor 24, which is also known in the prior art. The air governor 24 is additionally connected to the air compressor 21 and configured to control when the air compressor is turned on or turned off, depending on the amount of current air pressure in the system and on how much compressed air has been stored in the air storage tank 22.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An air dryer bypass device, comprising:
a housing having an inner passageway extending therethrough, wherein the inner passageway has a first end and a second end and is configured to contain pressurized air;
an intake port disposed on the housing at the first end of the inner passageway, connectable to an air compressor;
an output port disposed on the housing at the second end of the inner passageway, connectable to an air storage tank;
a regulator port in fluid communication with the inner passageway, connectable to an air pressure regulator device; and
a one way valve disposed inside the inner passageway in close proximity to the intake port, the one way valve configured to prevent air from exiting the passageway via the intake port.

2) The air dryer bypass device, further comprising a plate that is disposed on the housing adjacent to the output port, wherein the plate is configured with an aperture in alignment with the output port.

3) An air dryer bypass system, comprising:
an air compressor;
an air dryer bypass device operably connected to the air compressor, comprising:
a housing having an inner passageway extending therethrough, wherein the inner passageway has a first end and a second end and is configured to contain pressurized air;
an intake port disposed on the housing at the first end of the inner passageway, connectable to the air compressor;
an output port disposed on the housing at the second end of the inner passageway, connectable to an air storage tank;
a regulator port in fluid communication with the inner passageway, connectable to an air pressure regulator device; and
a one way valve disposed inside the inner passageway in close proximity to the intake port, the one way valve configured to prevent air from exiting the passageway via the intake port.
an air pressure regulator, connected to the air dryer bypass device and in fluid communication with the air compressor;
an air storage tank operably connected to the air dryer bypass device.

4) The air dryer bypass system of claim 3, wherein the air dryer bypass device further comprises a plate that is disposed on the housing adjacent to the output port, wherein the plate is configured with an aperture in alignment with the output port.

5) The air dryer bypass system of claim 4, wherein the plate is configured to be mounted directly to the air storage tank.

6) The air dryer bypass system of claim 3, wherein the air pressure regulator device is an air governor.
